(19) United States
(12) Patent Application Publication
(10) Pub. No.: US 2022/0236932 A1
(43) Pub. Date: Jul. 28, 2022

(54) INFORMATION PROCESSING APPARATUS, INFORMATION PROCESSING METHOD, AND STORAGE MEDIUM

(71) Applicant: TOSHIBA TEC KABUSHIKI KAISHA, Tokyo (JP)

(72) Inventor: Shinji OHIRA, Mishima Shizuoka (JP)

(21) Appl. No.: 17/159,465

(22) Filed: Jan. 27, 2021

(51) Int. Cl. G06F 3/12

(52) U.S. Cl. CPC G06F 3/1225; G06F 3/1258; G06F 3/1205; G06F 3/1204

(57) ABSTRACT

According to an embodiment, an information processing apparatus includes an interface configured to transmit commands to a first printer in a first-type protocol and commands to a second printer in a second-type protocol different from the first-type protocol. A processor of the information processing apparatus is configured to generate a command related to a setting in a print operation according to the second-type protocol from a setting according to the first-type protocol for the print operation and control the interface to transmit the command according to the second-type protocol to the second printer.

### FIELD

Embodiments described herein relate generally to an information processing apparatus, an information processing method, and a storage medium.

### BACKGROUND

In an image forming apparatus, such as a printer, there is a print controller that transmits commands to cause the image forming apparatus to print images or the like. Such a print controller is an information processing apparatus that utilizes a driver corresponding to the image forming apparatus.

In the related art, in a case where an information processing apparatus can cause a plurality of the image forming apparatuses to print images, it is necessary to install a driver corresponding to each of image forming apparatuses.

It would be preferable if an image processing apparatus could cause a plurality of image forming apparatuses to effectively print an image without requiring a different print driver for each.

### BRIEF DESCRIPTION OF THE DRAWINGS

FIG. 1 is a block diagram illustrating a printing system according to an embodiment.

FIG. 2 is a block diagram of an information processing apparatus.

FIG. 3 depicts a display example for an information processing apparatus.

FIG. 4 depicts another display example of an information processing apparatus.

FIG. 5 depicts another a display example of an information processing apparatus.

### DETAILED DESCRIPTION

According to an embodiment, an information processing apparatus includes an interface and a processor. The interface id configured to transmit commands to a first printer in a first-type protocol and commands to a second printer in a second-type protocol different from the first-type protocol. The processor is configured to generate a command related to a setting in a print operation according to the second-type protocol from a setting according to the first-type protocol for the print operation, and control the interface to transmit the command according to the second-type protocol to the second printer.

Hereinafter, certain non-limiting example embodiments will be described with reference to the drawings.

A printing system according to the embodiment causes the image forming apparatus to print an image according to an input operation from an operator or the like. The printing system transmits commands to the image forming apparatus according to selections and inputs made by the operator or the like. The image forming apparatus then prints an image according to a received command or commands. The image forming apparatus in this context can be a multifunction peripheral (MFP), for example.

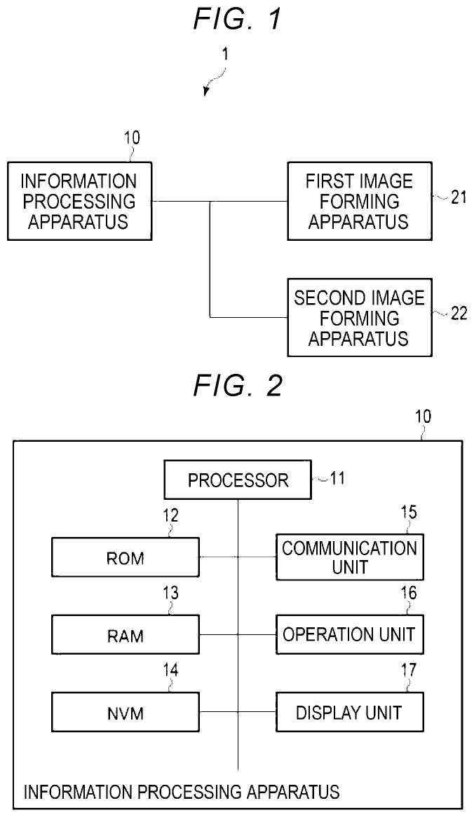

FIG. 1 illustrates a configuration example of a printing system 1 according to an embodiment. As illustrated in FIG. 1, printing system 1 includes an information processing apparatus 10, a first image forming apparatus 21, and a second image forming apparatus 22. The information processing apparatus 10 is connected to both the first image forming apparatus 21 and the second image forming apparatus 22.

The information processing apparatus 10 can cause either one of the first image forming apparatus 21 and the second image forming apparatus 22 to print an image. The information processing apparatus 10 is configured to transmit a command in a predetermined protocol (for example, a Printer Job Language (PJL), a Page Description Language (PDL), or a Printer Control Language (PCL) 6) to the first image forming apparatus 21 based on an input operation from an operator (user).

The first image forming apparatus 21 (also referred to as a first printer 21) prints an image on a medium such as a sheet of paper under the control of the information processing apparatus 10. The first image forming apparatus 21 prints an image according to commands transmitted from the information processing apparatus in the predetermined protocol. The first image forming apparatus 21 prints an image on the medium by, for example, an electrophotographic method, an inkjet method, or the like.

In this example, the first image forming apparatus 21 supports a command protocol according to a first-type specification (e.g., PDL). That is, the first image forming apparatus 21 is capable of interpreting commands provided according to the first-type specification (also referred to as a first protocol). The first image forming apparatus 21 performs a printing operation (or other operations) according to the commands of the first-type specification. The first image forming apparatus 21 is a multifunctional peripheral (MFP) device in this example.

The second image forming apparatus 22 (also referred to as a second printer 22) can also print an image on a medium such as a sheet paper under the control of the information processing apparatus 10. The second image forming apparatus 22 prints an image according to commands transmitted from the information processing apparatus 10. The second image forming apparatus 22 prints an image on the medium by, for example, an electrophotographic method, an inkjet method, or the like.

The second image forming apparatus 22 supports a command protocol of a second-type specification (e.g., PJL, PCL6, or the like) that is different from the first-type specification. That is, the second image forming apparatus 22 is capable of interpreting commands of the second-type specification (also referred to as a second protocol), but not necessarily of the first-type specification. The second image forming apparatus 22 performs a printing operation (or other operations) according to commands of the second-type specification.

The second image forming apparatus 22 is a multi-functional peripheral (MFP) device, for example. The second image forming apparatus 22 may have been manufactured by a vendor different from the vendor that manufactured the first image forming apparatus 21, for example.

In some examples, the printing system 1 may include three or more different image forming apparatuses. In addition, the printing system 1 may include just one image forming apparatus in some instances.

FIG. 2 illustrates a configuration example of an information processing apparatus 10 according to an embodiment. As illustrated in FIG. 2, the information processing apparatus 10 includes a processor 11, a ROM 12, a RAM 13, a non-volatile memory (NVM) 14, a communication unit 15, an input operation unit 16, a display unit 17, and the like.

The processor 11, the ROM 12, the RAM 13, the NVM 14, the communication unit 15, the input operation unit 16, and the display unit 17 are connected to each other via a data bus or the like.

The information processing apparatus 10 may have components in addition to the configuration illustrated in FIG. 2, and alternatively, some depicted components may be excluded from the information processing apparatus 10.

The processor 11 has a function of controlling overall operations of the information processing apparatus 10. The processor 11 may include an internal cache, various interfaces, and the like. The processor 11 performs various processes by executing a program (or programs) stored in an internal memory, such as the ROM 12, or the NVM 14.

In some examples, various functions of the processor 11 described as resulting from execution of a software program may instead be realized by a dedicated hardware circuit or the like. In such a case, the processor 11 still controls the functions performed by the hardware circuit.

The ROM 12 is a non-volatile memory in which control programs, control data, and the like can be stored in advance. The control programs and control data stored in the ROM 12 can be installed by a manufacturer or the like in advance according to the design specifications of the information processing apparatus 10.

The RAM 13 is a volatile memory. The RAM 13 is utilized to temporarily store data associated with processes being performed by the processor 11 or the like. Various application programs (or portions thereof) can be loaded on RAM 13 based on instructions from the processor 11. The RAM 13 may also store data required for executing application programs, execution results from application programs, and the like.

The NVM 14 is a non-volatile memory into which data can be written and rewritten. For example, the NVM 14 can be a storage medium such as a hard-disk drive (HDD), a solid-state drive (SSD), a flash memory, or the like. The NVM 14 stores control programs, applications, various data, and the like according to the operational needs of the information processing apparatus 10.

The communication unit 15 is an interface for transmitting and receiving data to and from the first image forming apparatus 21, the second image forming apparatus 22, and other connected components or devices. The communication unit 15 may transmit and receive data to and from the first image forming apparatus 21, the second image forming apparatus 22, and the like through a network. For example, the communication unit 15 supports a wired or wireless Local Area Network (LAN) connection. The communication unit 15 may support Universal Serial Bus (USB) connection. The communication unit 15 may be include an interface for transmitting and receiving data to and from the first image forming apparatus 21 and another interface for transmitting and receiving data to and from the second image forming apparatus 22.

The input operation unit 16 receives inputs from an operator or user of the information processing apparatus 10. The input operation unit 16 transmits a signal or signals indicating the received user input operations to the processor 11. The input operation unit 16 may comprise a touch panel and/or another other user input device.

The display unit 17 displays images under the control of the processor 11. For example, the display unit 17 is a liquid crystal display. If the input operation unit 16 comprises a touch panel, the display unit 17 may be formed integrally with the input operation unit 16.

The information processing apparatus 10 can be a desktop PC, a notebook PC, a tablet PC, a smartphone, a wearable terminal device (e.g., a watch), or the like.

Next, an operation example of an information processing apparatus 10 will be described. This example utilizes programs stored in the NVM and executed by the processor 11.

The processor 11 first installs a printer driver corresponding to the first image forming apparatus 21 according to the input operation from the operator or otherwise. That is, the processor 11 installs a printer driver that supports the first-type specification (first protocol). For example, the processor 11 installs the printer driver by executing an installer.

Once the driver is installed, the processor 11 then installs a plug-in corresponding to the second-type specification according to an input operation from the operator or otherwise. In this context, a plug-in is an auxiliary software component that extends or enhances the features of another software program or the like. In this example, the plug-in includes user-interface (UI) content and information about commands of the second-type specification. For example, the processor 11 installs the plug-in by executing an installer. The processor 11 utilizes the plug-in in conjunction with the printer driver.

In this example, the plug-in is a plug-in for generating commands according to the second-type specification. The printer driver is thus capable of converting various print settings of the first-type specification into print settings corresponding to the second-type specification by using commands of the second-type specification included in the plug-in. The printer driver (in conjunction with the plug-in) can thus generate commands according to the second-type specification to match the appropriate settings for a print operation or the like by the second image forming apparatus 22.

The plug-in also includes UI content that can be used for displaying a function or functions supported by the second image forming apparatus 22. The printer driver can cause functions supported by the second-type specification to be displayed by using the UI content included in the plug-in. For example, the UI content of the plug-in includes a layout of a screen, which can be a dedicated screen for second image forming apparatus 22 functions or the like. In the present example, the printer driver causes this dedicated screen to be displayed as one selectable tab or the like of a setting screen otherwise provided by the printer driver. The tab and the dedicated screen can be provided by the printer driver using the UI content of the plug-in. An example of a dedicated screen will be described below.

The processor 11 also checks the validity or invalidity of the plug-in to determine whether or not to display the dedicated screen and generate commands according to the second-type specification. If the plug-in is valid, the processor 11 displays the dedicated screen (by utilizing the printer driver) and can generate commands of the second-type specification based on the setting selections input via the dedicated screen. If the plug-in is invalid, the processor 11 generates commands of the first-type specification.

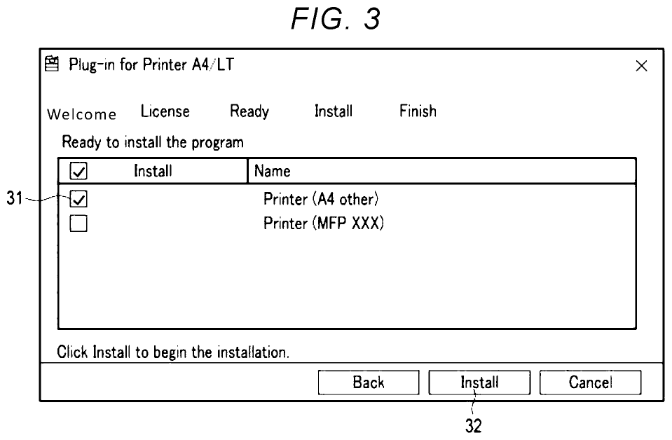

FIG. 3 is an example of an input screen by which the processor 11 receives an input for setting the plug-in to valid or invalid. For example, the processor 11 displays this input screen in the installation process of the plug-in.

For the example illustrated in FIG. 3, the name of the first image forming apparatus 21 is “Printer (MFPXXX).” The name of the second image forming apparatus 22 is “Printer (A4 other).”

As illustrated in FIG. 3, the input screen includes a check box 31 and a button icon 32 (“Install” button).

The check box 31 is associated with the name of the second image forming apparatus 22. The check box 31 receives an input for setting of the validity or invalidity of the plug-in.

User selection of the button icon 32 finalizes the setting of the validity or invalidity of the plug-in.

Thus, if the button icon 32 is pressed (or otherwise selected) while the check box 31 is checked, the processor 11 sets the plug-in to be valid. If the button icon 32 is pressed (or otherwise selected) while the check box 31 is not checked, the processor 11 sets the plug-in to be invalid.

After installing (or not) the plug-in, the setting of plug-in validity or invalidity may be changed by the processor 11 according to an input operation of the operator or otherwise. For example, the processor 11 may receive an input operation requesting the changing of the validity or invalidity of the plug-in through a setting screen or the like of the printer driver.

Next, an operation example in a case where the plug-in has been set to valid will be described. Itis assumed in this example that the user wants to print an image by using the second image forming apparatus 22.

The processor 11 first displays a dedicated screen for the second image forming apparatus 22 on the display unit 17. For example, if the processor 11 receives user input operation instructing a printing, the processor 11 initially displays the dedicated screen as one selectable tab or the like of a print setting screen by using the printer driver.

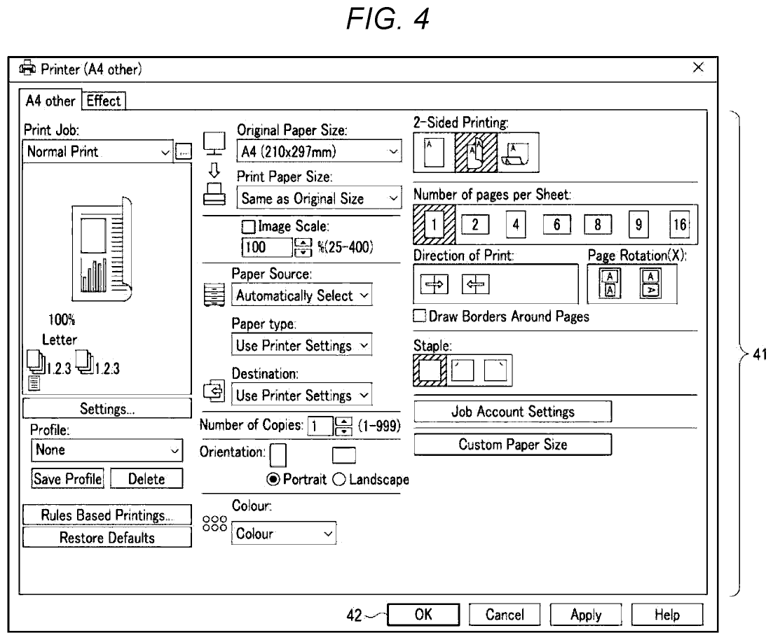

FIG. 4 illustrates an example of the dedicated screen for the second image forming apparatus 22. This dedicated screen illustrates the functions and possible print settings supported by the second image forming apparatus 22.

As illustrated in FIG. 4, the dedicated screen includes a display area 41 and a button icon 42 (“OK”).

The display area 41 displays the various functions supported by the second image forming apparatus 22. In addition, the display area 41 receives user input for making selections and setting parameters associated with a function or operation of the second image forming apparatus 22. That is, in this example, the display area 41 receives the user input (s) setting various parameters for the printing operation by the second image forming apparatus 22.

In the example illustrated in FIG. 4, the display area 41 receives the user input for settings related to a paper size, a scaling factor, a paper tray selection for supplying paper, a paper ejection destination, the number of copies to be printed, a paper orientation, a color mode, double-sided printing, number of pages per sheet (e.g., a n-up layout setting), a staple position, and the like. For example, the display area 41 receives the user inputs by pull-down menus, radio buttons, selectable icons, or the like.

In the display area 41, the contents of the pull-down menus (e.g., selectable options) and the like can be different from those that would be available for first image forming apparatus 21 operating with commands of the first-type specification. In addition, icons different from those that would be available for first image forming apparatus 21 operating with commands of the first-type specification can be displayed in the display area 41.

The button icon 42 is an icon for finalizing the settings/selections made in the display area 41.

Once the button icon 42 is pressed (or otherwise selected), the processor 11 determines what settings/selections have been input by the user in the display area 41.

Once the settings/selections input are determined, the processor 11 (executing the print driver) converts the settings/selections according to the first-type specification that have been input into settings/selections according to the second-type specification by using the printer driver in conjunction with the plug-in and thus the processor 11 is able to generate corresponding commands according to the second-type specification via the printer driver. For example, the processor 11 generates a command indicating the image to be printed and the various print settings indicated by the user in the display area 41. The processor 11 may generate a plurality of commands in some instances.

Once a command according to the second-type specification is generated, the processor 11 transmits the generated command to the second image forming apparatus 22 through the communication unit 15.

The second image forming apparatus 22 thus prints an image according to this generated command (which corresponds to the second command protocol) that is transmitted from the information processing apparatus 10.

Next, an operation example in a case where the plug-in is not utilized (invalid) will be described.

It is assumed in this example that the user wants to print an image by using the first image forming apparatus 21.

The processor 11 first displays a native screen of the print driver on the display unit 17 for displaying functions supported by the first image forming apparatus 21. That is, the native screen illustrates the functions supported by the first-type specification.

If user input, such as an input operation instructing printing, is received, the processor 11 displays the native screen as one selectable tab or the like on the setting screen of the printer driver.

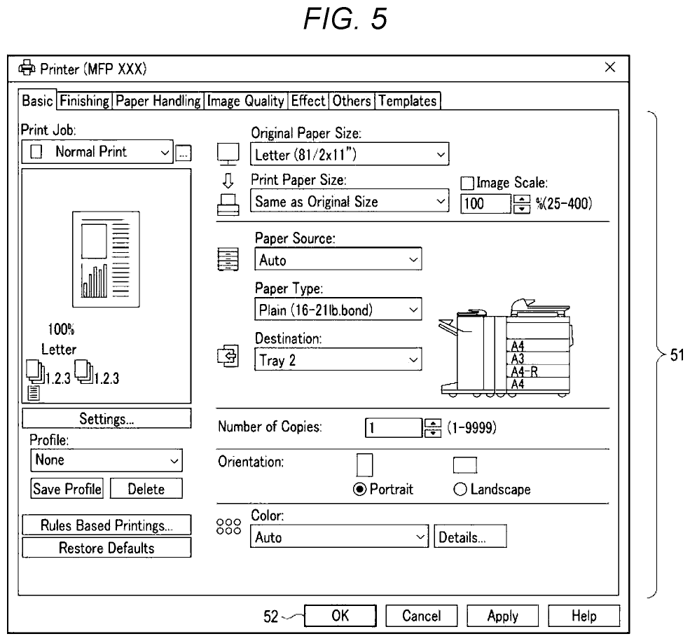

FIG. 5 illustrates an example of the native screen.

As illustrated in FIG. 5, the native screen includes a display area 51 and a button icon 52 (“OK”).

The display area 51 displays the various functions supported by the first image forming apparatus 21. In addition, the display area 51 receives the user input for making selections and setting parameters with a function or operation of the first image forming apparatus 21. That is, in this example, the display area 51 receives the user input setting various parameters for the printing operation by the first image forming apparatus 21.

In the example illustrated in FIG. 5, the display area 51 receives the user input of for settings related to a paper size, a scaling factor, a paper tray selection for supplying paper, a paper ejection destination, the number of copies to be printed, a paper orientation, a color mode, and the like. For example, the display area 51 receives the user inputs of the by pull-down menus, radio buttons, icons, or the like.

The button icon 52 is an icon for finalizing the settings/selections made in the display area 51.

Once the button icon 52 is pressed (or otherwise selected), the processor 11 determines what settings/selections have been input by the user in the display area 51.

Once the settings/selections input are determined, the processor 11 generates a command (or commands) corresponding to the first-type specification based on the input settings by using the printer driver. For example, the processor 11 generates a command indicating the image to be printed and the various print settings indicated by the user in the display area 51. The processor 11 may generate a plurality of commands in some instances.

The processor 11 transmits the generated first-type specification command to the first image forming apparatus 21 through the communication unit 15.

The first image forming apparatus 21 prints an image on paper according to this generated command transmitted from the information processing apparatus 10.

Additionally, the processor 11 may display a tab (for example, the “Effect” tab in FIG. 4) or the like for displaying functions common to each of the first and second command protocols.

In some examples, at least one of the first image forming apparatus 21 and the second image forming apparatus 22 may be a 3D printer.

The printing system 1 configured as described above utilizes a plug-in for converting a command of a first-type specification into a command of a second-type specification using a printer driver that only directly supports the first-type specification commands. The printing system 1 generates commands of the first-type specification by using the printer driver and then converts the generated commands into second-type specification commands by using the plug-in. As a result, the printing system 1 can control an image forming apparatus that supports only the second-type specification without using a printer driver that specifically supports the second-type specification.

In addition, the printing system 1, by using the plug-in, displays a screen for receiving user inputs for the settings for the second image forming apparatus 22 functions supported by the second-type specification. As a result, the printing system 1 can appropriately receive the user inputs for setting the various functions supported by the second image forming apparatus 22 and the second-type specification commands.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

1. An information processing apparatus, comprising:
an interface configured to transmit commands to a first printer in a first-type protocol and commands to a second printer in a second-type protocol different from the first-type protocol; and
a processor configured to:
generate a command related to a setting in a print operation according to the second-type protocol from a setting according to the first-type protocol for the print operation according, and
control the interface to transmit the command according to the second-type protocol to the second printer, wherein
the processor generates the commands in the first-type protocol using a printer driver for the first printer, and
the processor generates the commands in the second-type protocol from commands in the first-type protocol using a plug-in applied to the printer driver.

2. (canceled)

3. The information processing apparatus according to claim 1, further comprising:
a display configured to display images, wherein
the processor is configured to control the display to display a dedicated screen by using the printer driver, the dedicated screen illustrating functions supported by the second-type protocol for the second printer.

4. The information processing apparatus according to claim 3, wherein the processor is further configured to:
set the plug-in to valid or invalid, and
generate the command according to the second-type protocol only when the plug-in is valid.

5. The information processing apparatus according to claim 4, further comprising:
an input operation mechanism configured to receive user inputs for setting parameters of a function supported by the second-type protocol, wherein
the processor is configured to:
receive the parameters set via the input operation mechanism, and
generate commands according to the second-type protocol based on the set parameters.

6. The information processing apparatus according to claim 4, further comprising:
an input operation mechanism configured to receive user inputs for setting parameters of a print operation, wherein
the processor is configured to:
display an input screen that illustrates functions supported by the first-type protocol for the first printer when the plug-in is invalid, and
generate commands according to the first-type protocol based on the set parameters.

7. The information processing apparatus according to claim 3, wherein the processor is further configured to display the dedicated screen as one selectable tab of a setting screen provided by the printer driver.

8. An information processing method for a printer system including a first printer utilizing commands of a first protocol and a second printer utilizing commands of a second protocol, the method comprising:
executing a printer driver for generating commands in the first protocol, the printer driver being for the first printer;
using a plug-in applied to the printer driver, generating a print operation command related to a setting in a print operation according to the second protocol for the second printer from a setting according to the first protocol; and
controlling a communication interface to transmit the print operation command according to the second protocol to the second printer.

9. (canceled)

10. The information processing method according to claim 8, further comprising:
controlling a display to display a dedicated screen by using the printer driver, the dedicated screen illustrating functions supported by the second protocol for the second printer.

11. The information processing method according to claim 10, further comprising:
setting the plug-in to valid or invalid; and
generating the print operation command according to the second-type protocol only when the plug-in is valid.

12. The information processing method according to claim 11, further comprising:
receiving user inputs for setting parameters of a function supported by the second protocol via an input operation mechanism; and
generating commands according to the second protocol based on the set parameters.

13. The information processing method according to claim 11, further comprising:
displaying an input screen that illustrates functions supported by the first protocol for the first printer when the plug-in is invalid;
receiving user inputs for setting parameters of a function supported by the first protocol via an input operation mechanism; and
generating commands according to the first protocol based on the set parameters.

14. The information processing method according to claim 10, further comprising:
displaying the dedicated screen as one selectable tab of a setting screen provided by the printer driver.

15. A non-transitory computer-readable storage medium storing program instructions which when executed cause a processor of a printer system including a first printer utilizing commands of a first protocol and a second printer utilizing commands of a second protocol to perform a method comprising:
executing a printer driver for generating commands in the first protocol, the printer driver being for the first printer;
using a plug-in applied to the printer driver, generating a print operation command related to a setting in a print operation according to the second protocol for the second printer from a setting according to the first protocol; and
controlling a communication interface to transmit the print operation command according to the second protocol to the second printer.

16. (canceled)

17. The non-transitory computer-readable storage medium according to claim 15, the method further comprising:
controlling a display to display a dedicated screen by using the printer driver, the dedicated screen illustrating functions supported by the second protocol for the second printer.

18. The non-transitory computer-readable storage medium according to claim 17, the method further comprising:
setting the plug-in to valid or invalid; and
generating the print operation command according to the second-type protocol only when the plug-in is valid.

19. The non-transitory computer-readable storage medium according to claim 18, the method further comprising:
receiving user inputs for setting parameters of a function supported by the second protocol via an input operation mechanism; and
generating commands according to the second protocol based on the set parameters.

20. The non-transitory computer-readable storage medium according to claim 18, the method further comprising:
displaying an input screen that illustrates functions supported by the first protocol for the first printer when the plug-in is invalid;
receiving user inputs for setting parameters of a function supported by the first protocol via an input operation mechanism; and
generating commands according to the first protocol based on the set parameters.
